(19) United States
(12) Patent Application Publication
(10) Pub. No.: US 2009/0071766 A1
(43) Pub. Date: Mar. 19, 2009

(54) BRAKE PAD ASSEMBLY WITH WIDE SLOTS FOR THE REDUCTION OF NOISE

(75) Inventors: Matthew D. Gaulrapp, Brighton, MI (US); Nathanial D. Hincher, Pinckney, MI (US)

Correspondence Address: DOBRUSIN & THENNISCH PC, 29 W LAWRENCE ST, SUITE 210, PONTIAC, MI, 48342, US

(73) Assignee: AKEBONO CORPORATION (NORTH AMERICA)

(21) Appl. No.: 12/207,559

(22) Filed: Sep. 10, 2008

Related U.S. Application Data
(60) Provisional application No. 60/971,939, filed on Sep. 13, 2007.

(51) Int. Cl. F16D 55/22; F16D 65/092

(52) U.S. Cl. 188/72.1; 188/73.1

(57) ABSTRACT

The present invention is directed to a brake pad comprising a backing plate and a friction member carried on the backing plate. The friction member includes a single mass of material with a thickness, and having a first end and a second end, an upper edge, a lower edge, and an exposed braking surface for engaging a brake disc rotor, the exposed breaking surface being subdivided into at least two regions that are spaced apart by at least one slot having a longitudinal axis, which has a width of at least about 10 mm and which extends from the upper edge to the lower edge.

### CLAIM OF PRIORITY

The present invention claims the benefit of the priority of the filing date of U.S. Provisional Application Ser. No. 60/971,939 filed Sep. 13, 2007, which is herein incorporated by reference for all purposes.

### FIELD OF THE INVENTION

The present invention relates to brake systems and more specifically to brake systems employing slotted friction pads for reducing vibration and noise.

### BACKGROUND OF THE INVENTION

Brake noise such as squeal has long been a common problem for brake suppliers and vehicle manufacturers. This noise is a source of customer dissatisfaction resulting in warranty costs and loss of future sales. With respect to brake caliper systems for disc brake systems, sliding contact between the friction pads and a rotor during brake operation may excite the rotor to vibrate in various modes. These modes may be tangential (“in plane”) or normal (“out-of-plane”) with respect to the friction surfaces of the rotor disc. These modes are mainly influenced by the brake pad and rotor geometry. Historically manufacturers have sought to modify vibration response characteristics by dampening techniques such as the use of an insulator plate.

Traditionally, brake noise that has been attributed to the in-plane mode of the brake rotor has proven especially difficult to reduce. Under many circumstances, shortening the length of the friction material on the friction pad has helped in reducing noise. However, such re-design of the friction material results in a need to reconcile the resulting design with the original design intent to help improve caliper performance and reduce reliability issues. An approach that has been followed also has been to use chamfered ends on the friction pads. However, such solutions alone have tended not to avoid fatigue, piston cocking, or other issues. There remains a need in the art for brake systems that avoid one or more of the above issues.

### SUMMARY OF THE INVENTION

The present invention meets the above needs by providing an improved brake pad for a vehicle structure. By way of summary, the present invention is directed to a brake pad comprising a backing plate and a friction member carried on the backing plate. The friction member includes a single mass of material with a thickness, and having a first end and a second end, an upper edge, a lower edge, and an exposed braking surface for engaging a brake disc rotor. The exposed braking surface is subdivided into at least two regions that are spaced apart by at least one slot (e.g., two or more) having a longitudinal axis, which has a width (i.e., a space between the at least two regions) of at least about 10 mm, and which extends from the upper edge to the lower edge of the mass of material.

In another aspect the present invention is directed to a brake pad comprising a backing plate and a friction member carried on the backing plate. The friction member includes at least two slots subdividing the friction material into at least three contact regions having an exposed braking surface for engaging a brake disc rotor. The at least two slots having a first thickness that is less than the at least three contact regions having a second thickness. The at least two slots include a width that ranges from about 10 mm to about 50 mm. The at least two slots extend from an upper edge to a lower edge of the friction material. At least one of the at least two slots has a generally uniform initial depth of about 35 to about 65% of the thickness of the friction member.

In another aspect the present invention is directed to a corner module comprising a hub, a bearing, a knuckle, and a disc brake system. The brake system includes a caliper and a rotor. The caliper includes a brake pad having a backing plate and a friction member carried on the backing plate. The friction member includes a mass of material with a thickness. The friction material has a first end and a second end, an upper edge, a lower edge, and an exposed braking surface for engaging a brake disc rotor. The exposed braking surface being subdivided into at least two regions that are spaced apart by at least one slot having a longitudinal axis. The at least one slot has a width of at least about 10 mm and which extends from the upper edge to the lower edge.

In another aspect, the present invention provides a method of manufacturing a brake pad comprising the steps of applying a friction member to a backing plate and forming at least one slot thereby subdividing to form at least two contact regions, e.g., three or more contact regions. The at least one slot has a depth that extends to a slot bottom wall and is less than the thickness of the two contact regions. The at least one slot has a width of at least about 10 mm and extends from an upper edge to a lower edge of the friction member.

In yet another aspect, any of the aspects of the present invention may be further characterized by one or any combination of the following features: the friction member includes at least two slots, which each have a width of at least about 10 mm and extend from the upper edge to the lower edge; the at least one slot is defined by two generally parallel opposing walls, which are straight, arcuate, or a combination thereof; the slot has a generally uniform initial depth of about 35 to about 65% of the thickness of the friction member; the longitudinal axis of the at least one slot is aligned substantially non-orthogonally relative to a tangent of the upper edge at the site of intersection of the tangent with the axis; the brake pad further includes at least one chamfered surface at the first end or second end of the pad; the at least one slot includes a surface exhibiting characteristics of a molding process performed thereon, a machining process performed thereon, or a combination thereof; the width of the at least one slot has a first width at the upper edge and a second width at the lower edge that differs from the first width; the at least one slot separates the first end from the second end into the at least two contact regions of equal width or of different width; the at least one slot includes a profile relative to the upper edge, the lower edge, or both having a portion including a flat side wall, an arcuate side wall, a flat bottom, an arcuate bottom, a portion substantially resembling a U-shape, a portion substantially resembling a V-shape, or any combination thereof; vehicle cabin noise occurrence is greater than 50 dB less than about 20% of the time; the brake pad exhibits an average minimum life of at least 18,500 miles, a vehicle cabin noise level that does not exceed about 50 dB or a combination of both; the at least two slots separate the first end from the second end into the a first contact region and a second contact region of equal widths, with a third contact region formed between the at least two slots that is a different width than the first contact region of the first end and the second contact region of the second end; the ratio of the width of the at least two slots to the width of the third contact region may range from about 1:2 to about 1:8; the at least two slots include a profile relative to an upper edge, a lower edge, or both having a portion including a flat side wall, an arcuate side wall, a flat bottom, an arcuate bottom, a portion substantially resembling a U-shape, a portion substantially resembling a V-shape, or any combination thereof; the at least two slots include two generally parallel opposing walls extending to a bottom wall of the at least two slots through corner regions having a generally arcuate shape, thereby substantially defining a U-shape slot profile, the generally opposing walls are generally perpendicular to the exposed braking surface of the at least three contact regions; or any combination thereof.

It should be appreciated that the above referenced aspects and examples are non-limiting as others exist with the present invention, as shown and described herein. For example, any of the above mentioned aspects or features of the invention may be combined to form other unique configurations, as described herein, demonstrated in the drawings, or otherwise.

### BRIEF DESCRIPTION OF THE INVENTION

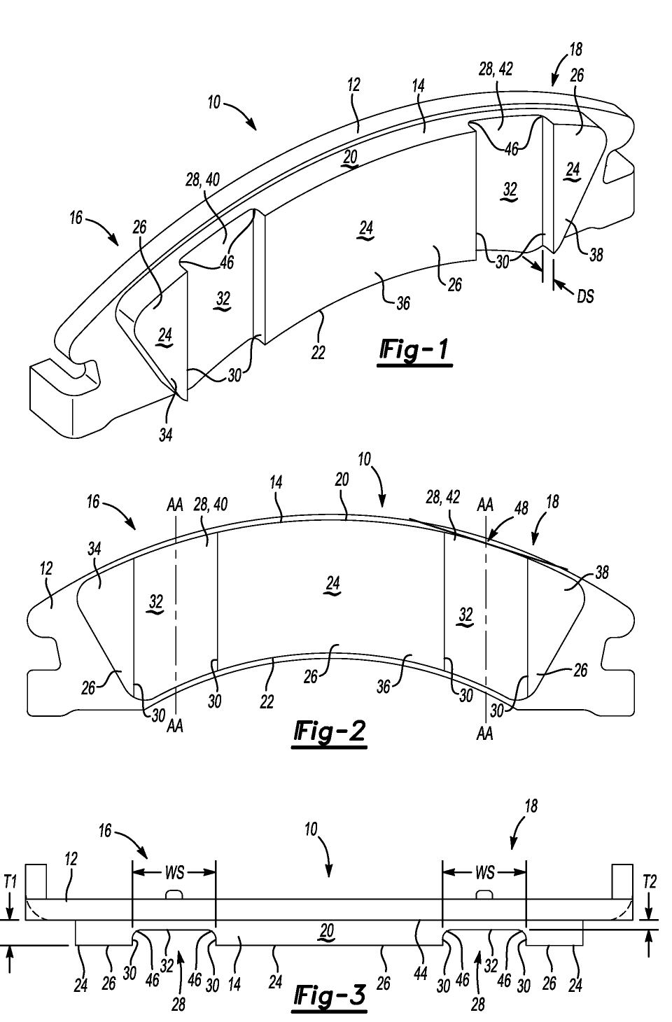

FIG. 1 illustrates a perspective view of one embodiment herein.

FIG. 2 illustrates a top view of the embodiment of FIG. 1.

FIG. 3 illustrates a side view of the embodiment of FIG. 2.

### DETAILED DESCRIPTION OF THE INVENTION

The present invention is directed towards an improved brake pad 10, configured for reducing brake noise, such as brake squeal. More particularly, with reference to FIGS. 1-3, a brake pad 10 includes a backing plate 12 and a friction member 14 carried on the backing plate. The friction member 14 includes at least one single mass of material with a thickness T1, and having a first end 16 and a second end 18, an upper edge 20, a lower edge 22, and an exposed braking surface 24 for frictionally engaging the brake disc rotor (not shown) and causing the rotor to slow. The exposed braking surface is subdivided to form at least two contact regions 26 (three regions are illustrated) that are spaced apart by at least one slot 28 (two slots are illustrated) having a longitudinal axis AA. At least one of the slots 28 (and possibly both) has a width of at least about 10 mm and extends from the upper edge 20 to the lower edge 22.

It is contemplated that the number of slots and the slot location, relative to the first end 16 and the second end 18 of the friction member may be varied according to the needs of the overall disc brake system. Furthermore, multiple masses of material may be employed on a single backing plate having at least one of the slotted configurations discussed herein. Referring to the drawings, FIG. 1 illustrates one embodiment of the present invention, which provides a friction member 14 that includes a first slot 40 and a second slot 42. The slots include opposing walls 30 and a bottom wall 32 extending therebetween and generally parallel to the exposed surface 24. The opposing walls 30 generally extend inward of the exposed surface 24 towards the bottom wall 32. The friction member 14 further includes a bottom surface 44 that is supported by the backing plate 12.

For the specific embodiment shown in the drawings, the first and second slots 40, 42 are disposed within the friction member, thus producing an exposed surface 24 in three contact regions (e.g., first contact region 34, second contact region 36, and third contact region 38) that are above the recessed bottom walls 32 of the two slots. The two slots are generally similar in profile and extend from the upper edge 20 to the lower edge 22 of the friction member. For example, the two slots have substantially the same depth along the profile from the upper edge to the lower edge. Furthermore, the slots are positioned in a region generally proximate to the first end 16 and second end 18, of the friction member.

As in FIG. 3, the two generally parallel opposing walls 30 extend to the bottom wall 32 through corner regions 46 having a generally arcuate shape, thereby substantially defining a U-shape slot profile. It is contemplated that one or both of the corner regions 46 may be flat, arcuate, or combinations thereof. The opposing walls 30 are generally perpendicular to the exposed surface 24; however, it is appreciated that the opposing walls 30 may be inclined, stepped, arcuate, or otherwise. Preferably, the opposing walls 30 intersect the upper and the lower edges, 20, 22, respectively, which are generally arcuate. As such, as shown in the embodiments of the drawings, the longitudinal axis M of the slot may be aligned substantially non-orthogonally relative to a tangent of the upper edge at the site 48 of intersection of the tangent with the axis AA. It is possible, however, that one or more slots are orientated radially, such that the longitudinal axis AA is substantially orthogonal with the tangent at the site of intersection with the axis.

With reference to FIG. 3, the width of the slot WS, is measured as the maximum width of a given slot profile. Typically, this width is measured between each opposing wall 30 at the intersection of the upper edge, the lower edge, or both. In one embodiment, the width of the slot is uniform from the upper edge to the lower edge; however, it is contemplated that the width of the slot may vary from the upper edge 20 to the lower edge 22. For example, the width may expand or contract progressing from the upper edge to the lower edge. By way of example, the slot width WS may range from about 10 to about 50 mm. With specific reference to FIG. 2, the slots 40, 42 have a width of about 20 mm to about 40 mm (e.g., about 30 mm) and are separated therebetween by a second contact region 36 that has a width of about 60 to about 85 mm (e.g., about 72 mm). It is further contemplated that the width WS may be the same or different from one slot to another and that the overall number of slots vary from one disc brake design to another. By way of example, one embodiment herein contemplates the use of two slots arranged to define the second contact region 36. The present invention has the ability to provide numerous types of slot dimensions with different lengths, widths, heights, or combinations thereof. For example, the ratio of the width of at least one of the slots to the width of the second contact region may range from about 1:2 to about 1:8, and more specifically about 1:3 to about 1:5.

With reference to FIG. 3, the depth of the slot DS is measured from the exposed surface 24 of the contact region 34, 36, and 38 (e.g., the first contact region, the second contact region, and the third contact region) to the bottom wall 32 of the slot. The slot depth is generally constant from the upper edge to the lower edge, however, depending on the slot profile, it is contemplated that the slot depth may vary from the upper edge to the lower edge, between the opposing walls 30, or combinations thereof. Furthermore, it is contemplated that the slot depth may vary from slot to slot (e.g., one slot may be deeper than another).

Depth of the slots can also be expected based upon the thickness of the friction member. For the present invention, it is believed that the greater the depth, the longer the life of reduced brake noise. Although, a slot that is too deep can potentially cause undesirable stress and fatigue issues. As such, there is generally a trade-off, wherein removing material is helps reduce brake noise, removing too much material may prematurely cause wear within the brake pad. It is appreciated with the numerous types of slot dimensions and friction member thicknesses available with the present invention, the depth of the slot with respect to the thickness of the friction member may vary from one brake pad to another. For example in one preferred embodiment, the slot has a uniform initial depth of about 15 to about 80%, and specifically, about 25 to about 65% (e.g., about 3 mm deep for a member having a thickness of about 10 mm) of the thickness of the friction member.

With reference to FIG. 3, the thickness of the slot T2 is measured from the bottom wall 32 of the slot to a bottom surface 44 of the friction member. The slot thickness T2 is less than the thickness T1 of the contact regions 34, 36, and 38, which are generally defined from the exposed surface 24 to the bottom surface 40 of the friction member.

Generally, the brake pads herein may be employed as part of a brake system, such as a disc brake system that includes a rotor and a caliper. Such system may be provided as part of a corner module that includes other components such as a hub, a bearing, a knuckle, or any combination thereof. The brake pads herein may further comprise at least one chamfered surface at the first end 16 or second end 18 of the pad. The chamfered surface may provide additional strength to the end portions, reduce the overall weight of the brake pad, enable the brake pad and more specifically the caliper assembly to fit within the wheel hub spaces, otherwise, or combinations thereof. In one embodiment, the chamfered surface at the first end 16 and the second end 18 of the of the friction member are generally parallel to a chamfered surface of the caliper body housing, such as a finger portion, a cylinder portion, a bridge portion, therebetween, or combinations thereof.

In one exemplary method of manufacturing a brake pad herein, a friction member is attached to a backing plate, and then forming one or more slots by subdividing the friction member into at least two contact regions. At least one slot having a thickness that is less than the thickness of at least one contact region.

The slot may be formed by removing material from the exposed surface of the friction member so as to define a recess in the friction member. For example, material may be removed (e.g. by grinding) from the friction member by engaging the surface of the friction member with a material removal tool. As such, the bottom wall of the slot is axially displaced with respect to the exposed surface of the contact region.

In one specific example, the method of manufacturing a brake pad may include the steps of applying a friction member to a backing plate and forming at least one slot thereby subdividing at least two contact regions such that the at least one slot has a first thickness that is less than at least one of the at least two contact regions having a second thickness. The at least one slot has a width of at least about 10 mm and extends from an upper edge to a lower edge of the friction member. In one aspect, the step of forming the at least one slot may be achieved by removing material from the friction member by engaging the exposed surface of the friction member with a material removal tool. The resulting amount of material removed from the friction member may be less than in the at least one contact region so that a height differential results between the exposed surface of contact region and the bottom wall of the at least one slot. In another aspect, the at least one slot has a bottom wall that may be axially displaced with respect to the exposed surface of the at least one contact region such that upon braking, the exposed surface of the at least one contact region engages a rotor prior to the bottom wall of the at least one slot.

Without intending to be bound by theory, the present invention is believed to unexpectedly reduce brake noise by reducing the potential for modal coupling to occur between the deformation modes of the rotor and the brake pad. As such, the present invention seeks to improve on prior brake assemblies and particularly to change the natural frequency mode of the rotor/brake pad system, more specifically the friction member as it engages the disc portion of a rotor, so that the frequency of the noise falls within a predetermined target frequency mode. This is accomplished by providing an improved brake pad having at least one slot feature located about the exposed surface of the friction member and without the need to add additional noise dampening material. Additionally, this is accomplished while substantially avoiding caliper fatigue, wear, or both, and maintaining acceptable brake pad stiffness. As such, it is appreciated that the brake pad of the present invention is customizable to meet customer requirements/specifications for vehicle noise performance. In one exemplary embodiment, a brake pad of the present invention exhibits an average minimum life of at least about 18,500 miles while still exhibiting vehicle cabin noise levels below 50 dB, according to conventional traffic simulation tests, such as the Los Angles City Traffic Test (LACT). Under such testing, a mix of city and freeway driving is utilized for simulating on-road braking conditions for vehicles. Further, as compared with brake pads that did not include a slot as described herein, the occurrence of brake noise levels in the pads of the present invention of greater than 50 dB is believed to be less than about 20% and more preferably less than about 10% the occurrence of such levels in unslotted pads.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such features may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A brake pad, comprising:
a backing plate; and
a friction member carried on the backing plate;
wherein the friction member includes a single mass of material with a thickness, and having a first end and a second end, an upper edge, a lower edge, and an exposed braking surface for engaging a brake disc rotor, the exposed braking surface being subdivided into at least two regions that are spaced apart by at least one slot having a longitudinal axis, which has a width of at least about 10 mm and which extends from the upper edge to the lower edge.

2. The brake pad of claim 1, wherein the friction member includes at least two slots, which each have a width of at least about 10 mm and extend from the upper edge to the lower edge.

3. The brake pad of claim 1, wherein the at least one slot is defined by two generally parallel opposing walls, which are straight, arcuate, or a combination thereof.

4. The brake pad of claim 1, wherein the slot has a generally uniform initial depth of about 35 to about 65% of the thickness of the friction member.

5. The brake pad of claim 1, wherein the longitudinal axis of the at least one slot is aligned substantially non-orthogonally relative to a tangent of the upper edge at the site of intersection of the tangent with the axis.

6. The brake pad of claim 1, further comprising at least one chamfered surface at the first end or second end of the pad.

7. The brake pad of claim 1, wherein the at least one slot includes a surface exhibiting characteristics of a molding process performed thereon, a machining process performed thereon, or a combination thereof.

8. The brake pad of claim 1, wherein the width of the at least one slot has a first width at the upper edge and a second width at the lower edge that differs from the first width.

9. The brake pad of claim 1, wherein the at least one slot separates the first end from the second end into the at least two contact regions of equal width or of different width.

10. A brake pad of claim 1, wherein the at least one slot includes a profile relative to the upper edge, the lower edge, or both having a portion including a flat side wall, an arcuate side wall, a flat bottom, an arcuate bottom, a portion substantially resembling a U-shape, a portion substantially resembling a V-shape, or any combination thereof.

11. A brake pad of any of the claims 1, wherein vehicle cabin noise occurrence is greater than 50 dB less than about 20% of the time.

12. The brake pad of claim 1, wherein the brake pad exhibits an average minimum life of at least 18,500 miles, a vehicle cabin noise level that does not exceed about 50 dB or a combination of both.

13. A brake pad comprising:
a backing plate; and
a friction member carried on the backing plate;
wherein the friction member includes at least two slots subdividing the friction material into at least three contact regions having an exposed braking surface for engaging a brake disc rotor, the at least two slots having a first thickness that is less than the at least three contact regions having a second thickness, and
wherein:
i) the at least two slots include a width that ranges from about 10 mm to about 50 mm;
ii) the at least two slots extend from an upper edge to a lower edge of the friction material; and
iii) at least one of the at least two slots has a generally uniform initial depth of about 35 to about 65% of the thickness of the friction member.

14. The brake pad of claim 13, wherein the at least two slots separate the first end from the second end into the a first contact region and a second contact region of equal widths, with a third contact region formed between the at least two slots that is a different width than the first contact region of the first end and the second contact region of the second end.

15. The brake pad of claim 14, wherein the ratio of the width of the at least two slots to the width of the third contact region may range from about 1:2 to about 1:8.

16. A brake pad of claim 14, wherein the at least two slots include a profile relative to an upper edge, a lower edge, or both having a portion including a flat side wall, an arcuate side wall, a flat bottom, an arcuate bottom, a portion substantially resembling a U-shape, a portion substantially resembling a V-shape, or any combination thereof.

17. The brake pad of claim 14, wherein the at least two slots include two generally parallel opposing walls extending to a bottom wall of the at least two slots through corner regions having a generally arcuate shape, thereby substantially defining a U-shape slot profile, the generally opposing walls are generally perpendicular to the exposed braking surface of the at least three contact regions.

18. A brake pad of any of the claims 16, wherein vehicle cabin noise occurrence is greater than 50 dB less than about 20% of the time.

19. The brake pad of claim 16, wherein the brake pad exhibits an average minimum life of at least 18,500 miles, a vehicle cabin noise level that does not exceed about 50 dB, or a combination of both.

20. A corner module comprising a hub, a bearing, a knuckle, and a disc brake system having a caliper and a rotor, the caliper includes a brake pad having:
a backing plate; and
a friction member carried on the backing plate;
wherein the friction member includes a mass of material with a thickness, and having a first end and a second end, an upper edge, a lower edge, and an exposed braking surface for engaging a brake disc rotor, the exposed braking surface being subdivided into at least two regions that are spaced apart by at least one slot having a longitudinal axis, which has a width of at least about 10 mm and which extends from the upper edge to the lower edge.
